(19) United States
(12) Patent Application Publication
(10) Pub. No.: US 2009/0038741 A1
(43) Pub. Date: Feb. 12, 2009

(54) Removable repair label

(76) Inventor: Mark J. Mueller, Shiocton, WI (US)

Correspondence Address: PPG INDUSTRIES INC;INTELLECTUAL PROPERTY DEPT, ONE PPG PLACE, PITTSBURGH, PA, 15272, US

(21) Appl. No.: 11/891,654

(22) Filed: Aug. 10, 2007

(51) Int. Cl. B32B 37/12; B32B 33/00

(52) U.S. Cl. 156/152; 428/41.3

(57) ABSTRACT

A removable label for adhering to an object undergoing a repair is disclosed. The label includes a polymeric film comprising a front side and a back side, the back side comprising an adhesive composition for removably attaching the film to an object. Repair indicia is present on the front side of the film for entering information on the object undergoing repair.

### FIELD OF THE INVENTION

This invention relates to removable labels for adhering to an object undergoing repair.

### BACKGROUND OF THE INVENTION

Auto body repair typically is performed in an auto body repair shop. When a vehicle is damaged, the owner of the vehicle brings the vehicle to the auto body repair shop to receive an estimate for the repair of the vehicle's apparent damage. Personnel at the auto body shop prepare an estimate based on the damage that is visible to the exterior of the vehicle. Upon authorization by the owner and, where applicable, insurance approval is gained for performing the work, the repair shop begins the repair process. An estimate of the repair necessary involves an estimate of the time needed to perform the repair, as well as the cost for components required to accomplish the repair.

When the repair work commences, a “repair order” is created. The repair order usually is manifested as a paper form that remains with the vehicle during the repair process. This paper form is placed inside the vehicle, such as in a sleeve placed on the dashboard or hung from the rear view mirror. When repair tasks are completed or other updates to the repair order are needed, the repair shop personnel remove the paper form from the vehicle to write on the form. A problem with paper-based forms for tracking repair processes is that the paper form tends to get separated from the vehicle. Also, the paper form is easily torn or damaged during the repair process, making it difficult to obtain a useful permanent record of the repair process.

In other situations, the repair process is tracked by writing or marking directly on the vehicle with a washable marker, or the like, such as on the windows or on the vehicle body to indicate portions of the vehicle that require repair, or to draw attention to repair personnel. While such marking is not likely to become separated from the vehicle, the marking may get washed off or abraded during the repair process, such that some of the information is lost before the repair is even completed. In addition, temporary markers can stain the windows or body of a vehicle.

### SUMMARY OF THE INVENTION

The present invention includes a removable label for adhering to an object undergoing repair. The label includes a polymeric film comprising a front side and a back side, the back side comprising an adhesive composition for removably attaching the film to an object and repair indicia on the front side for entering information on the object undergoing repair. The present invention also includes a method of verifying performance of tasks in a process of repairing an object comprising providing a computer-generated repair label, the label comprising (i) a polymeric film comprising a front side and a back side, the back side comprising an adhesive composition for removably attaching the film to an object, and (ii) repair indicia on the front side for entering information on the object being repaired; adhering the label to the object; and periodically entering information regarding the object being repaired on the label until the repair process is complete.

### BRIEF DESCRIPTION OF THE DRAWINGS

FIG. 1 illustrates a repair order label of the present invention;

FIG. 2 illustrates a checklist repair label of the present invention;

FIG. 3 illustrates a vehicle having the labels of FIGS. 1 and 2 adhered to the windows thereof;

FIG. 4a illustrates a repair mapping label of the present invention;

FIG. 4b illustrates another repair mapping label of the present invention;

FIG. 4c illustrates yet another repair mapping label of the present invention;

FIG. 5a illustrates a vehicle bearing the repair mapping label of FIG. 4a; and

FIG. 5b illustrates the vehicle shown in FIG. 5a and includes the additional repair mapping label of FIG. 4b.

### DETAILED DESCRIPTION OF THE INVENTION

The present invention includes repair labels and a method of verifying performance of tasks in a process of repairing an object. Although the present invention is described in relationship to the repair of a vehicle, such as a vehicle undergoing repair at an auto body repair shop, this is not meant to be limiting. The present invention is applicable to other objects undergoing repair, such as appliances.

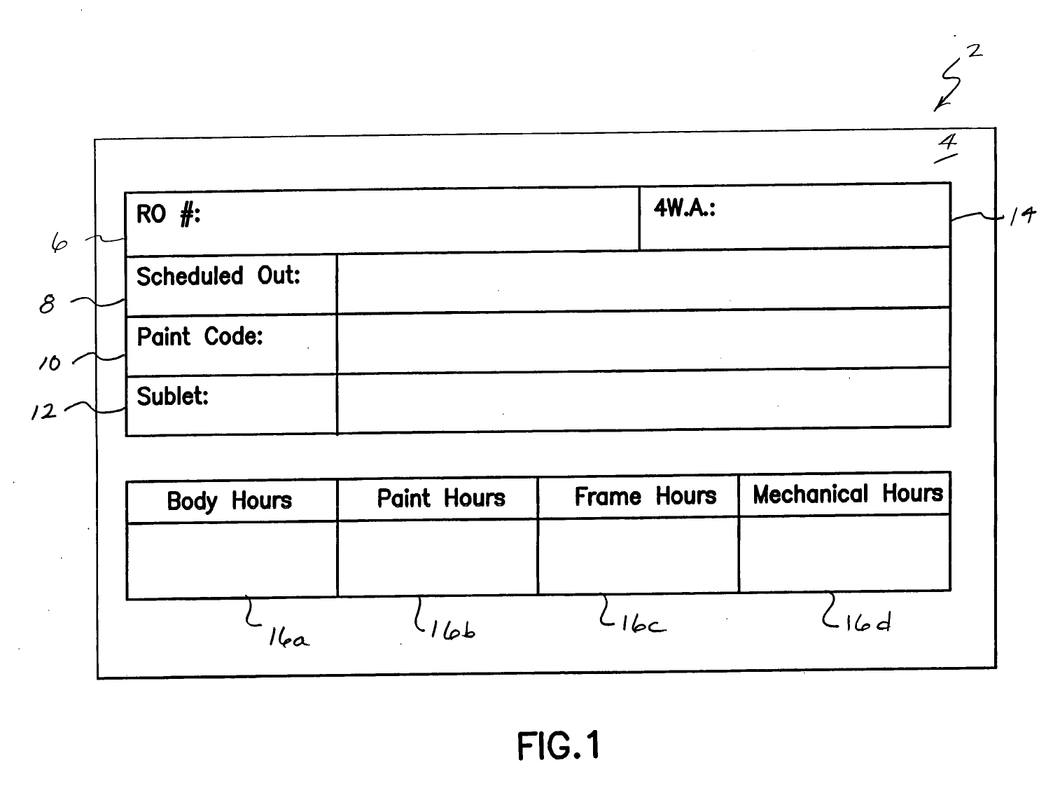

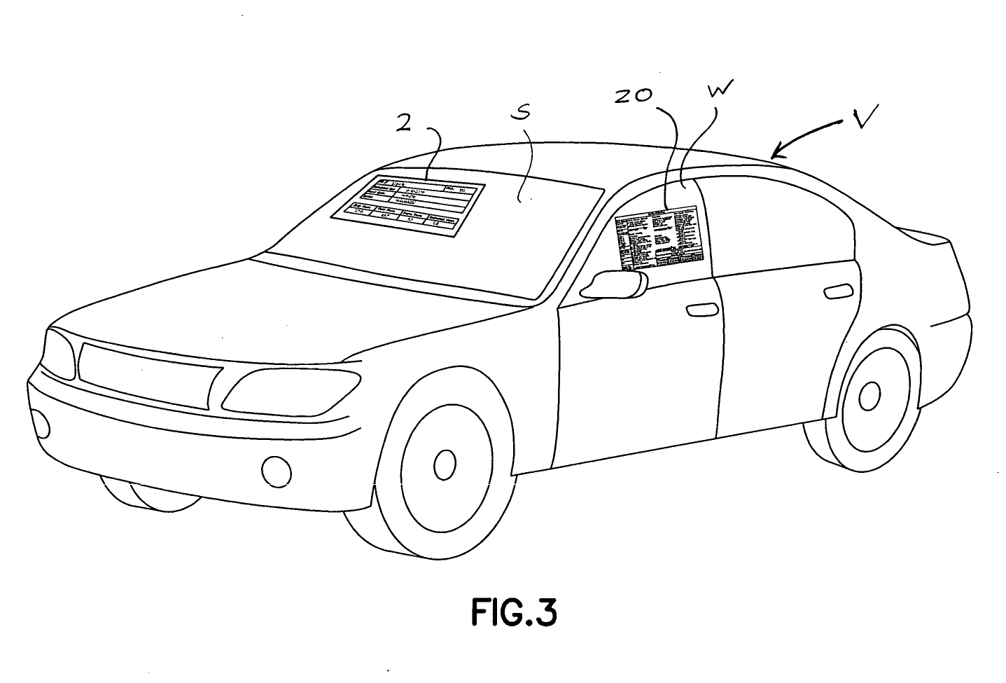

As shown in FIGS. 1-3, the present invention includes removable labels 2, 20 for adhering to an object such as a vehicle V. The repair order label 2 shown in FIG. 1 includes a polymer film having a front side 4 and a back side (not shown). The back side includes an adhesive composition for removably attaching the polymeric film to an object such as a vehicle. By removably attaching, it is meant, attaching the label to an object undergoing repair in a manner by which removal thereof is performable manually without specialized tools, solvents or the like. A suitable adhesive is a pressure sensitive acrylic adhesive. The adhesive may be covered with a liner (not shown) that is removed prior to use in a conventional manner. Suitable polymeric films may be produced from polyvinyl chloride-based compositions. The thickness of the film may vary depending on the end use and the number of times the label will be adhered and removed. For use in auto body repair, the film thickness may be about 2-10 mil, such as about 4.5 mil. The front side 4 of the repair label 2 includes repair indicia 6-16d for entering information regarding the object undergoing repair. For example, the repair order (RO) label 2 shown in FIG. 1 as including indicia with blank areas for entering the repair order number (RO# 6), the date that the vehicle is scheduled to be completed (Scheduled Out 8), the paint to be applied to the vehicle (Paint Code 10), an indication of whether any repair needs to be contracted with another repair shop (Sublet 12) and an indication of whether any four-wheel alignment is required (4W.A. 14). An estimate of the labor hours required to complete the repair, broken down by types of labor, including body hours, paint hours, frame hours, and mechanical hours, are included in the indicia as at 16a, 16b, 16c and 16d, respectively. By body hours, it is meant the length of time expected for performing repair to the body of the vehicle. Paint hours refers to the length of time expected to prepare and paint the body surfaces. Frame hours refers to the length of time expected for repairing and/or aligning the frame of the vehicle. Mechanical hours refers to the length of time expected for repairing any mechanical system damage to the vehicle. The repair label 2 provides an overview of the repair that is required to be completed on the vehicle. The repair label 2 may be removably adhered to the windshield S of the vehicle V as shown in FIG. 3, thereby providing a clear summary of the estimated repair required for the vehicle V. In one embodiment, the repair label 2 is brightly colored, such as yellow, to clearly stand out in an auto body repair shop. The repair indicia 6-16d appearing on the repair label 2 are not limited by those shown in FIG. 1, or as described herein. Other repair indicia may be included on the repair label 2. In use, the repair label 2 may be written on with a writing instrument such as a pen containing permanent ink, so that the information concerning the repair order is permanently maintained on the repair label 2. The repair order label 2, though, is removably attached to the windshield S or other window W of the vehicle V.

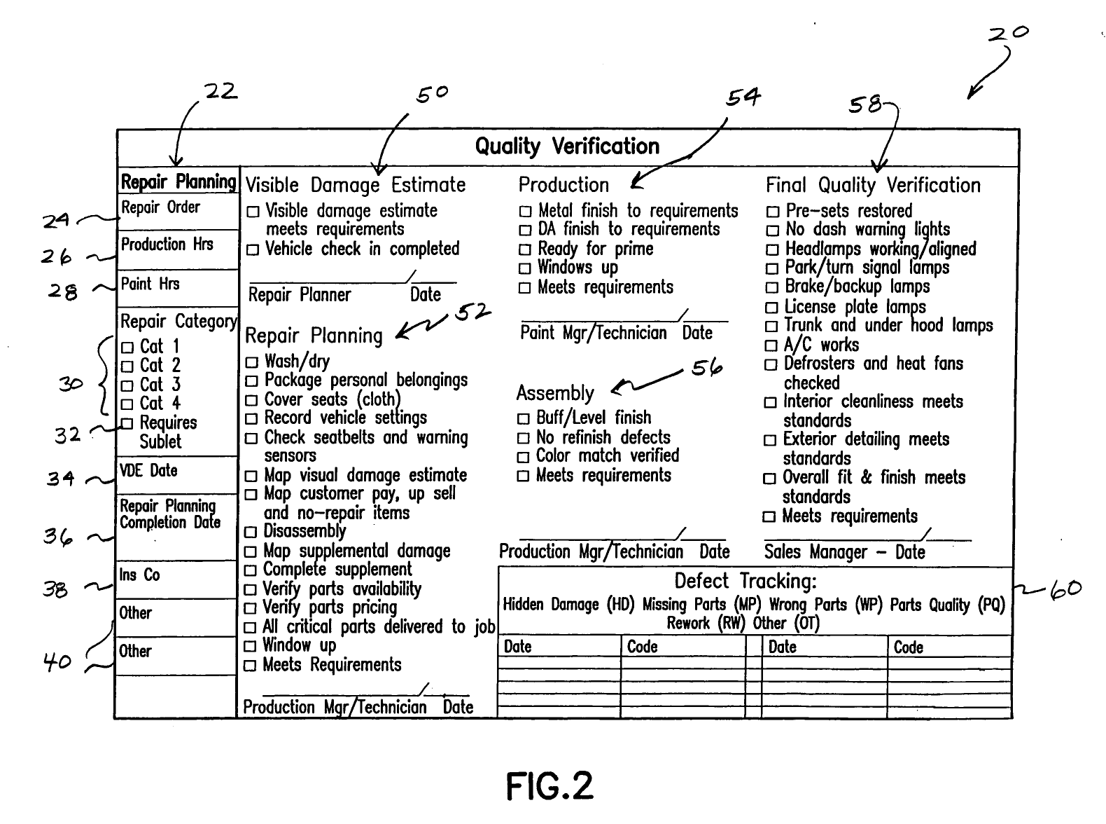

In another embodiment shown in FIG. 2, a checklist repair label 20 is produced from a polymeric film as described above and may include repair planning indicia 22. The repair planning indicia 22 may include blanks for entering the repair order number 24, such as entered on repair order label 2, an estimate of production hours 26 and paint hours 28, and an indication of the severity of the repair 30, such as by category numbers (Cat. 1, Cat. 2, Cat. 3 or Cat. 4) rating the level of repair from minor to severe. The repair category section also includes an indication 32 that the repair requires subletting to a contractor, such as would be indicated in the repair indicia of the repair order label 2. Also included in the repair planning indicia 22 is a visual damage estimate (VDE) date 34 for entering when the estimate of the visual damage was performed, repair planning completion date 36 indicating the date on which the repair planning was completed, the insurance company name (Ins Co) 38 where applicable and other optional blank areas 40 for entering other relevant information. While not intending to be limited thereto, the checklist repair label 20 of FIG. 2 shows five checklists 50, 52, 54, 56 and 58 for verifying completion of a repair process. For each checklist, a check mark is made in a block to indicate that the associated repair process has been completed. Upon completion of each of the components of these individual checklists, the appropriate personnel in the repair shop signs and dates the bottom thereof. The particular information indicated in the checklist repair label is exemplary only. Other checklists may be included on the checklist repair label and other information may be included within each checklist. The checklist repair label may also include a portion 60 for indicating defects in the repair process, such as may occur due to hidden damage (HD), missing parts that were not available at the time of the repair (MP), wrong parts that were ordered in error to complete the repair (WP), parts quality (PQ) indicative of inferior parts that have been received for completing the repair, reworking of a repair step (RW), or other repair defects (OT). The date on which each of these defects is noted and their respective codes may be entered onto the checklist repair label. As with the repair order label 2, the checklist repair label 20 is written upon, such as with permanent ink, so as to have a permanent record of the completion of a repair process. The checklist repair label 20 is shown in FIG. 3 as being positioned on the driver's side window W of vehicle V, but labels 2 and 20 may be positioned on any surface of vehicle V.

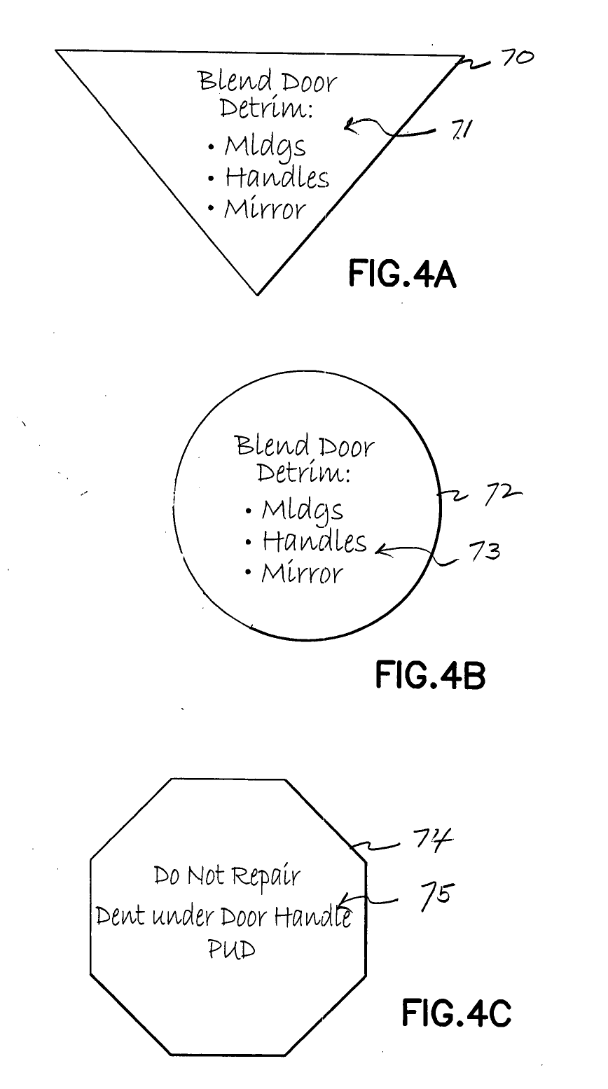

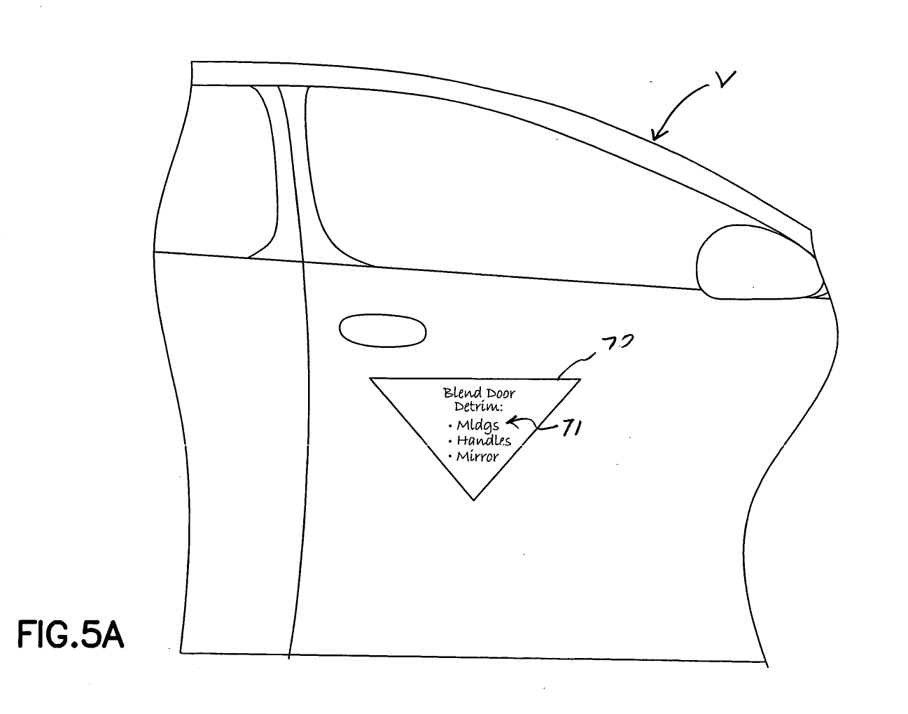

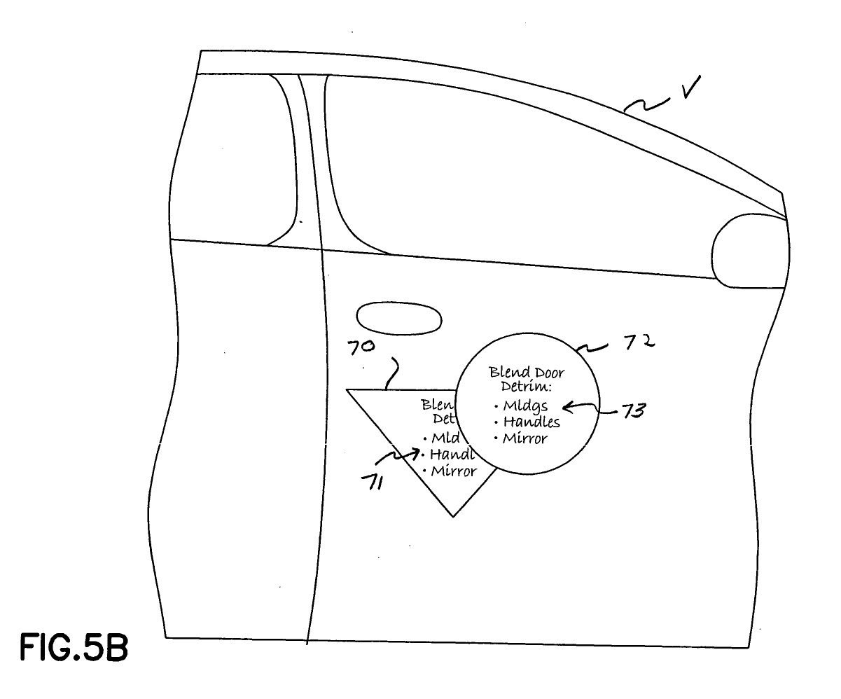

In another embodiment, the present invention includes removable labels for marking a particular location of a vehicle undergoing repair. FIGS. 4A-4C illustrate removable repair labels 70, 72, 74 that may be applied to a vehicle V undergoing repair as needed. In use, when a vehicle comes into a body shop for repair with damage that the body shop personnel are unclear whether to repair, question label 70 may be applied on or near the questioned location as shown in FIG. 5A. The question label 70 may be written upon or otherwise marked to indicate the type and scope of damage in question. The indicia 71 shown in FIG. 7A is an example of handwritten notes added to question label 70. Alternatively, repair shop personnel may identify either hidden damage or damage that was not part of the original estimate and may wish to question whether repair to that portion of the vehicle should be performed. The question label 70 may be applied to the vehicle label as a visual reminder to determine if the newly discovered damage should be repaired. Upon resolution of the question of whether the damage marked by question label 70 is to be repaired, the repair label indicating to proceed with the repair 72 (FIG. 4B) or to not repair 74 (FIG. 4C) may be placed adjacent or overlying the question label 70. Each of the proceed to repair label 72 and not repair label 74 may also be written upon or marked to indicate what repair is to be completed (as shown via indicia 73 of label 72) or state to not repair (as shown via indicia 75 of label 74). The not repair label 74 also may be used during preparation of a repair order. When a vehicle arrives and the owner knows of prior damage that is not to be repaired, the not repair label 74 may be applied to the location of prior damage. In this manner, the body shop personnel have a readily visible label that indicates if a particular damage should be included within a repair order. In one embodiment, the labels 70, 72 and 74 are shaped and/or colored to communicate this information. For example, the question label 70 that provides an alert to question if a repair is desired, may be colored yellow and/or triangular shaped as to mimic a yield sign. The proceed to repair label 72 may be circular and/or colored green to indicate a go-ahead or green light. Finally, the no repair label 74 that indicates no repair is necessary may be configured in an octagon shape and colored red as mimicking a stop sign. These colors and shapes of labels 70, 72 and 74 are not meant to be limiting.

All of the preferred embodiments of the present invention are described above, obvious modifications and alterations of the present invention may be made without departing from the spirit and scope of the present invention. The scope of the present invention is defined in the appended claims and equivalents thereto

The invention claimed is:

1. A removable label for adhering to an object undergoing repair comprising:
a polymeric film comprising a front side and a back side, the back side comprising an adhesive composition for removably attaching the film to an object; and
repair indicia on said front side for entering information on the object undergoing repair.

2. The label of claim 1, wherein the repair indicia comprise repair order number, estimated repair completion date, estimated repair hours, repair part product code, and/or repair subcontractor.

3. The label of claim 2, wherein the object is a vehicle and the repair indicia include repair order number; estimated repair completion date; estimated hours to complete body work, paint work, frame work and/or mechanical work; paint code; repair subcontractor; and/or four wheel alignment.

4. The label of claim 1, wherein the repair indicia comprise repair planning information and/or repair process information.

5. The label of claim 4, wherein the object is a vehicle and the repair planning information comprises repair order, estimated production hours, estimated paint hours, degree of repair, date of visual damage estimate, date of repair planning completion, and/or insurance company.

6. The label of claim 5, wherein the repair process information comprises a visual damage estimate checklist, a repair planning checklist, a production checklist, an assembly checklist and/or a quality verification checklist.

7. The label of claim 6, wherein the repair indicia further comprise information on defects in repair planning and/or repair process.

8. The label of claim 1, wherein the label is configured to indicate whether to (i) proceed with a repair, (ii) question if a repair is desired, or (iii) not to repair.

9. The label of claim 8, wherein the label to proceed with a repair is green, the label to question if a repair is desired is yellow and the label to not repair is red.

10. A method of verifying performance of tasks in a process of repairing an object comprising:
providing a computer-generated repair label, the label comprising (i) a polymeric film comprising a front side and a back side, the back side comprising an adhesive composition for removably attaching the film to an object and (ii) repair indicia on the front side for entering information on the object being repaired;
adhering the label to the object; and
periodically entering information regarding the object being repaired on the label until the repair process is complete.

11. The method of claim 10, wherein the object is a vehicle.

12. The method of claim 11, wherein the information is entered on the label using permanent ink.

13. The method of claim 11, further comprising adhering a plurality of labels to the object.

14. The method of claim 13, wherein the indicia on one of the labels includes repair order number, estimated repair completion date, estimated repair hours, repair part product code, and/or repair subcontractor.

15. The method of claim 13, wherein the indicia on one of the labels includes a checklist of repair steps.

16. The method of claim 15, wherein the checklist of repair steps comprises a visual damage estimate checklist, a repair planning checklist, a production checklist, an assembly checklist, and/or a quality verification checklist.

17. The method of claim 15, further comprising entering information on repair planning, the information comprising repair order number, estimated production hours, estimated paint hours, degree of repair, date of visual damage estimate, date of repair planning completion, and/or insurance company.

18. The method of claim 13, wherein one of the labels is configured to indicate whether to (i) proceed with a repair, (ii) question if a repair is desired, or (iii) not to repair.

19. The method of claim 18, further comprising applying the label to question if a repair is needed to a location on the vehicle not scheduled for repair.

20. The method of claim 19, further comprising determining if the location should be repaired and applying one of the label to proceed with repair or the label to not repair.
